(19) United States
(12) Patent Application Publication
(10) Pub. No.: US 2004/0263085 A1
(43) Pub. Date: Dec. 30, 2004

(54) Organic light-emitting diode display device

(76) Inventors: Yen-Hua Chen, Tantz Shiang (TW); Shin-Tai Lo, Miaoli City (TW); Chih-Chung Chien, Shituen Chiu (TW)

Correspondence Address: BIRCH STEWART KOLASCH & BIRCH, PO BOX 747, FALLS CHURCH, VA, 22040-0747, US

(21) Appl. No.: 10/602,891

(22) Filed: Jun. 25, 2003

(51) Int. Cl. G09G 3/10

(52) U.S. Cl. 315/169.1

(57) ABSTRACT

An organic light-emitting diode display device has a scan line layout that has different sizes of pixel areas depending on their scan line distance to control the display areas. For the line which has a shorter distance and lower voltage drop, the pixel display area is greater. On the contrary, the line which has a greater distance and greater voltage drop, the pixel display area is smaller. Therefore each display pixel has the same current density. Thereby the entire organic light-emitting diode display device has an uniform display brightness.

### FIELD OF THE INVENTION

The present invention relates to an organic light-emitting diode (OLED) display device for improving uniformity of image display brightness on the OLED display device.

### BACKGROUND OF THE INVENTION

Organic Light-Emitting Diode (OLED), or called Organic Electroluminescence (OEL), is a new generation of display technology superior to other flat panel display technologies. It can generate clear and flexible full color images at a quick response speed.

The basic structure of OLED includes a thin and transparent anode made from Indium Tin Oxide (ITO) that has semiconductor properties and a metal cathode to sandwich layers of organic material therebetween. The organic layers include a hole transport layer (HTL), a light emitting layer (EL), and an electron transport layer (ETL). When a battery provides a suitable constant current (a low voltage), electric charges injected into the electric holes of the anode couple with the charges from the cathode to agitate the organic material to generate electroluminescence. The structure of the organic layers and design selection of the anode and cathode are the critical factors that enable the OLED device to generate light effectively.

OLED has many characteristics, including: generates light by itself, does not need back light modules, low voltage driving (less than 10 Volts) and saves power consumption, high energy efficiency (16 1 m/W), greater brightness (100,000 cd/m² or above), shorter response time (less than 21 s), greater contrast, wide viewing angle (proximate to 180°), light weight, thin, simple structure, low fabrication cost, flexible (plastics based) and full color enabling.

Therefore OLED has been used widely, and has a great market potential on display devices or illumination equipment, such as mobile phones, game players, audio system panels, digital cameras, personal digital assistant (PDA), car navigation systems, electronic books, information appliances, notebook computers, monitors, TVs, and the like.

The methods for driving OLED may be classified in passive driving and active driving. The passive driving has the advantages of generating instant display of a great brightness (dynamic driving/selective), having chips attached to the panels, linear and gradual scanning, easier stage tuning control, lower cost/high voltage driving, easy to make design changes, short delivery time (simple manufacturing processes), etc. The active driving has the advantages of continuous display (steady driving), TFT driving circuit design/built-in thin film driving IC, linear and gradual writing data, forming organic EL pixels on the TFT substrate, low voltage driving/low electric power consumption/higher cost, the display element has a longer service life time (but more complex manufacturing processes), etc.

Conventional passive driving OLED display device, particularly those that have a larger area and higher resolution, due to a higher scanning cycle and a greater instant current, when the output power of the driving circuit does not fully meet the driving capability required by the panel, the scan lines on the panel will have a greater voltage drop variation due to differences of impedance value on the lines. As a result, the driving current flowing through each pixel is different. When the current density is different, display brightness is not uniform.

U.S. Pat. No. 6,459,208, entitled “Active Matrix Electroluminescent Display Device” assigned to Philips Co. discloses a design using active matrix OLED (AMOLED). It has the advantage of improving uneven brightness caused by voltage drop. But it also has draw backs of a complicated structure, and difficult to achieve total bright uniformity.

### SUMMARY OF THE INVENTION

Therefore the primary object of the invention is to resolve the aforesaid disadvantages and eliminate the drawbacks occurred to the prior art. The invention aims to improve the uneven display brightness resulting from driving IC power constraint of the display pixel caused by driving a large size OLED display device, high resolution, or too much impedance of layout lines.

The invention employs the characteristics that each scan line has a decreasing brightness and lower current density as its distance from the driving source becomes greater, therefore gradually decreases the display area along the scan lines. As the diodes of the same OLED display device have same properties, the display brightness mainly depends on current density. The two main factors affect the current density are current and display area. When the line width of scan line layout of the cathode is changed and the line width of data line layout of the anode remains the same, the display areas are different, therefore current density may become the same, thereby image uniformity may be enhanced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of the layout of a conventional OLED display panel.

FIG. 2 is a schematic diagram of the layout of the OLED display panel of the present invention.

FIG. 3 is a schematic diagram of the OLED layout of an OLED display panel.

FIG. 4 is a schematic diagram of a scan line layout of the present invention.

FIG. 5 is a schematic diagram of a data line layout of the present invention.

### DETAILED DESCRIPTION OF THE PREFERRED EMBODIMENT

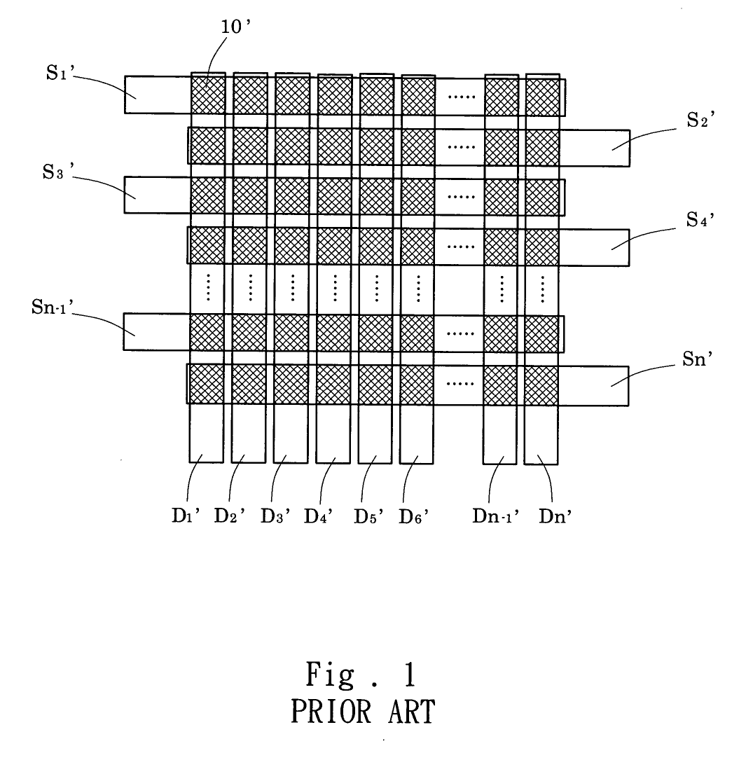

Please refer to FIG. 1 for a conventional OLED display panel layout. It includes cathodes consisting of scan lines S1′, S2′, S3′, S4′, . . . , Sn-1′, Sn′ that have the same width and anodes consisting of data lines D1′, D2′, D3′, D4′, D5′, D6′ . . . , Dn-1′, Dn′ that have the same width. The overlapped areas of the cathodes and the anodes are the display areas 10′ of the OLED display panel.

Taken the first scan line S1′ as an example. As OLED receives instant current from n data lines D1′, D2′, D3′, D4′, D5′, D6′ . . . , Dn-1′, Dn′, when instant current on S1′ is great, voltage drop on the scan line S1′ will make the driving current source of the data lines D1′, D2′, D3′, D4′, D5′, D6′ . . . , Dn-1′, Dn′ difficult to output a constant current. As a result, the brightness of OLED will be affected. The cathode of the display area at S1′/D1′ is most closed to the driving source of the scan line S1′, it has the smallest voltage drop and the data line D1′ has a stable driving current. The cathode of the display area at S1′/Dn′ is farthest from to driving source of the scan line S1′, it has the greatest voltage drop and the driving current on the data line Dn′ tends to deviate from the normal value. Compared with the display area S1′/D1′, current density at display S1′/Dn′ is smaller. Based on aforesaid phenomenon, the current density of various display areas varies as follows: S1/‘D1’>S1′/D2′>S1′/D3′> . . . >S1′/Dn-1>S1′/Dn′. On the other hand, taken the second scan line S2′ as an example, the cathode of S2′/D1′ is farthest from the driving source of the scan line S2′ and has the greatest voltage drop, therefore the driving current on the data line D1′ tends to deviate from the normal value, while the cathode of S2′/Dn′ is most closed to the driving source and has the smallest voltage drop, hence the driving current on the data line Dn′ is more stable. The current density relationship is as follows: S2′/D1′<S2′/D2′<S2′/D3′< . . . <S2′/Dn-1<S2′/Dn′.

In order to resolve the aforesaid problems, the invention provides a technique to improve the uneven brightness. The invention aims at achieving uniform brightness by controlling and reaching same current density.

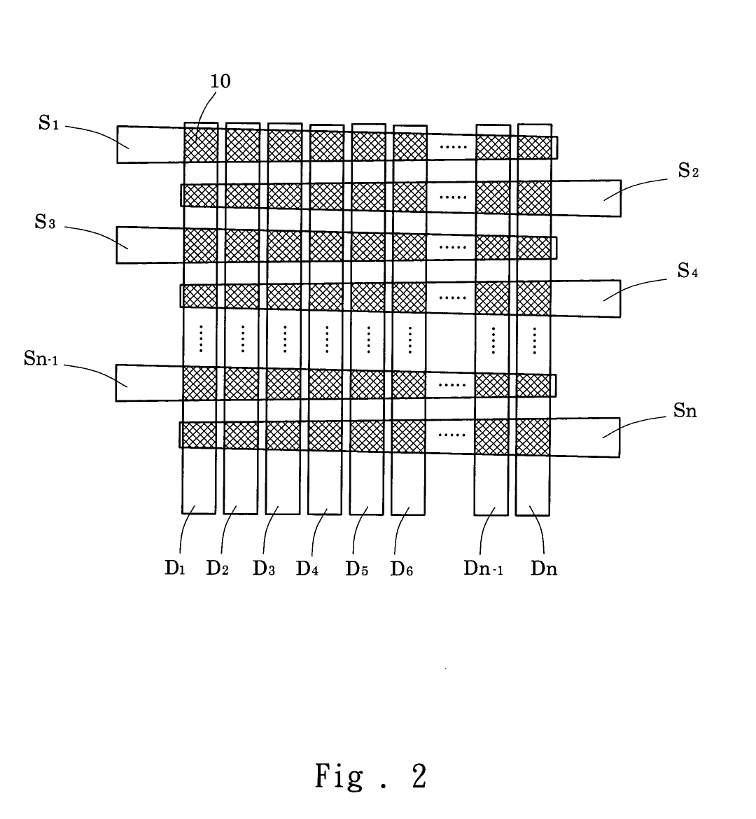

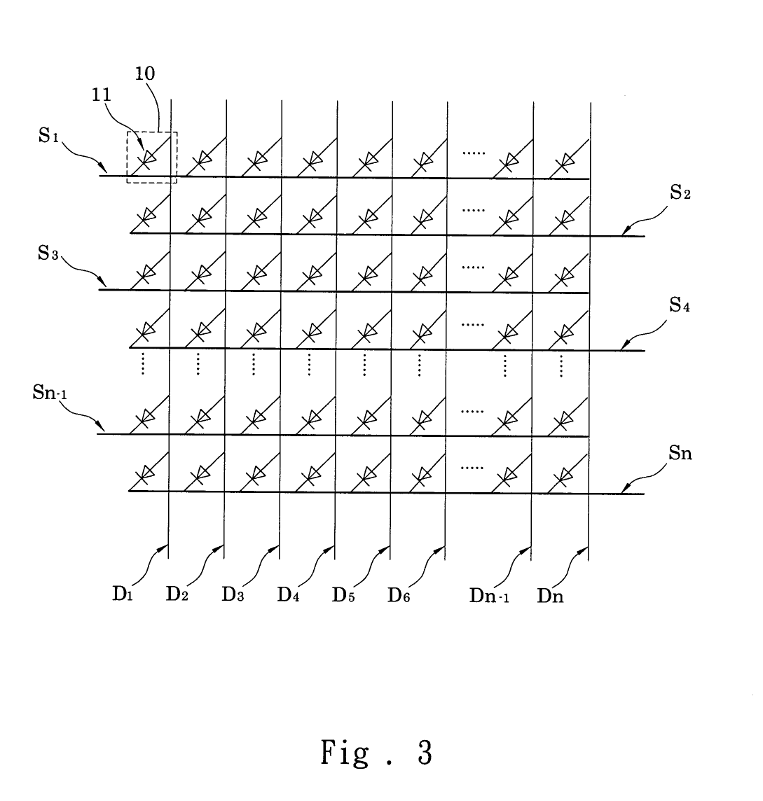

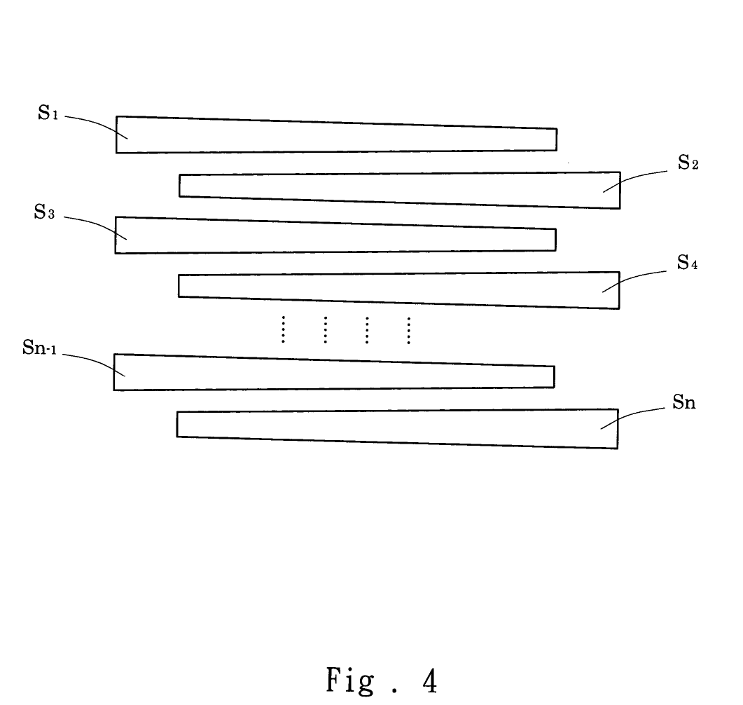

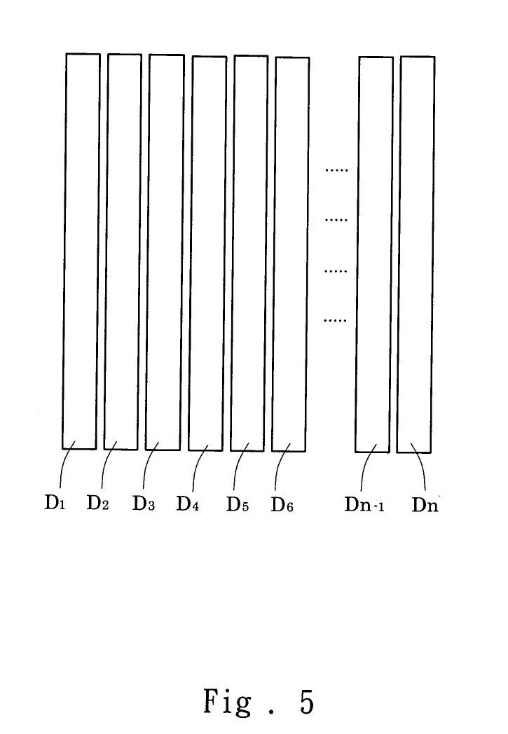

Refer to FIGS. 2 and 3 for the layout of the OLED display panel and OLED layout of the present invention. As shown in the drawings, the invention employs such a technique: in the event that the brightness and current density of the scan lines S1, S2, S3, S4, . . . , Sn-1, Sn decrease gradually, shrink the OLED display area 10 gradually; in the event that the brightness and current density increase gradually, increase the OLED display area 10 gradually so that current density on each display area is the same and the brightness may become uniform. Therefore, according to the invention, as the scan lines S1, S2, S3, S4, . . . , Sn-1, Sn that are spaced from the driving source at a greater distance have decreasing brightness and current density, the OLED display areas 10 also decrease gradually along the scan lines. As the diodes 11 on the same OLED display device have same properties (referring to FIG. 3), the brightness mainly depends on current density. There are two main factors affecting the current density: current and display area 10. When the width of the scan lines S1, S2, S3, S4, . . . , Sn-1, Sn is changed along the layout of the lines (as shown in FIG. 4) and the width of the data lines D1, D2, D3, D4, D5, D6, . . . , Dn-1, Dn remains the same (as shown in FIG. 5), the area relationship of the display areas 10 becomes S1/D1>S1/D2>S1/D3>S1/D4>S1/D5>S1/D6> . . . >S1/Dn-1>S1/Dn. Then current density becomes the same, i.e. S1/D1=S1/D2=S1/D3=S1/D4=S1/D5=S1/D6=. =S1/Dn-1=S1/Dn. Thus uniformity of image brightness can be enhanced.

In other words, the invention aims at achieving equal current density to reach the end of uniform display brightness to compensate the driving circuit which cannot provide driving power to satisfy the panel and offer a simple panel layout to improve variations of voltage drop. The invention merely alters the conventional layout without affecting manufacturing processes. It does not increase manufacturing cost and also can improve crosstalk of the panel. In addition, the pixel driving current may increase and the display area which the current flows through is greater, circuit layout may be optimized.

While the preferred embodiment of the invention has been set forth for the purpose of disclosure, modifications of the disclosed embodiment of the invention as well as other embodiments thereof may occur to those skilled in the art. Accordingly, the appended claims are tended to cover all embodiments which do not depart from the spirit and scope of the invention.

What is claimed is:

1. An organic light-emitting diode display device, comprising:
a set of scan lines formed by a cathode layer of the organic light-emitting diode display device; and
a set of data lines formed by an anode layer of the organic light-emitting diode display device;
wherein the scan lines and the data lines are overlapped to form pixel display areas, the scan lines being formed in a selected layout such that those scan lines closer to a scan line electric source end have a greater width and those scan lines spaced from the scan line electric source end at a greater distance have a narrower width.

2. The organic light-emitting diode display device of claim 1, wherein each of the display area includes an organic light-emitting diode.

3. The organic light-emitting diode display device of claim 1, wherein the data lines have a same width throughout the layout.
